(19) United States
(12) Patent Application Publication
(10) Pub. No.: US 2013/0272010 A1
(43) Pub. Date: Oct. 17, 2013

(54) LIGHT SOURCE MOUNTING STRUCTURE OF VEHICULAR LAMP

(71) Applicant: KOITO MANUFACTURING CO., LTD., Tokyo (JP)

(72) Inventor: Naoshi Kawamura, Shizuoka-shi (JP)

(73) Assignee: KOITO MANUFACTURING CO., LTD., Tokyo (JP)

(21) Appl. No.: 13/856,595

(22) Filed: Apr. 4, 2013

(30) Foreign Application Priority Data
Apr. 12, 2012 (JP) 2012-090638

(51) Int. Cl. F21V 19/00

(52) U.S. Cl. CPC F21S 48/00
USPC 362/519

(57) ABSTRACT

The present disclosure provides a light source mounting structure including a bulb mounting hole provided in a reflector, a socket fixture configured to be fixed to the bulb mounting hole, and a bulb including a bayonet flange configured to be inserted into the bulb mounting hole and, when rotated, to be engaged with the socket fixture. The socket fixture is integrally provided with a snap fit that is capable of being elastically deformed and configured to be engaged with the bayonet flange. The bulb is easily mounted due to the elastic deformation of the snap fit and is also suppressed from being detached. The snap fit is integrally formed with the socket fixture, and thus, the number of components may be reduced.

### CROSS-REFERENCE TO RELATED APPLICATIONS

This application is based on and claims priority from Japanese Patent Application No. 2012-090638, filed on Apr. 12, 2012, with the Japan Patent Office, the disclosure of which is incorporated herein in its entirety by reference.

### TECHNICAL FIELD

The present disclosure relates to a lamp to be equipped on a vehicle such as, for example, a car, and specifically, to a light source mounting structure configured to be mounted in a lamp body.

### BACKGROUND

Various elements such as, for example, an incandescent bulb (a light bulb), a discharge bulb, and a light-emitting element, have been provided as a light source of a vehicular lamp. However, these light sources adopt a detachable mounting structure with respect to a lamp body in order to enable the maintenance of the lamp. A so-called bayonet structure is generally adopted as the mounting structure of these light sources. Specifically, when the light source is a bulb, the bayonet structure is often adopted since the life span of the bulb is shorter than that of the light-emitting element and the bayonet structure allows the light source to be easily mounted/detached. An example of such a light source mounting structure is disclosed in Japanese Patent Application Laid-Open No. 05-135603. In the light source mounting structure, a socket fixture is fixed to a bulb mounting hole provided in the rear surface of a reflector and a petal-shaped flange (hereinafter, referred to as a “bayonet flange”) is provided on a part of a bulb. The bulb may be mounted in the reflector by inserting the bayonet flange through a concave portion provided in the socket fixture to the inner side of the socket fixture and rotating the bulb about the axis thereof so that the bulb is press-fitted and sandwiched in a gap between the bulb mounting hole and the socket fixture. Further, the term “bulb” may be used in the present disclosure to refer to the entirety of an integrally formed product including a socket unit that holds the bulb, in addition to mean a light bulb.

### SUMMARY

In the configuration where a bayonet flange is sandwiched in a gap between a bulb mounting hole and a socket fixture as disclosed in Japanese Patent Application Laid-Open No. 05-135603, the sandwiched state of the bayonet flange may be loosened by, for example, external force or vibration applied to the bulb, and thus, the bulb may fall out. For that reason, Japanese Patent Application Laid-Open No. 05-135603 adopts a configuration in which a protrusion is formed in the bulb mounting hole and, when the bayonet flange is rotated to be sandwiched, the bayonet flange rides over the protrusion so that a part of the bayonet flange is engaged with the protrusion in the rotation direction to prevent the reverse rotation thereof, thereby maintaining the sandwiched state. However, in such a configuration, the rotation torque is increased when the bayonet flange rides over the protrusion, and thus, a high manipulating force is required to mount a bulb. Further, the protrusion may be easily worn out by the frictional engagement of the protrusion and the bayonet flange at this time, and thus, when the bulb is repeatedly mounted/detached, the rotation prevention function may be deteriorated due to the wear-out of the protrusion. To avoid the deterioration, in Japanese Patent Application Laid-Open No. 05-135603, a leaf spring member is interposed between the bulb mounting hole and the socket fixture so that the bayonet flange may easily ride over the protrusion using the elastic force of the leaf spring, and the sandwiched state may be secured by causing the bayonet flange to be elastically contacted with the bulb mounting hole. For that reason, a leaf spring is needed as a component of the bulb mounting structure in addition to the socket fixture, which becomes a factor that increases the number of the components and brings about the high cost.

The present disclosure has been made in consideration of this situation and provides a light source mounting structure which is capable of securing a stable sandwiched state of the light source without increasing the number of components.

A light source mounting structure according to the present disclosure includes: a light source mounting hole provided in a reflector; a socket fixture configured to be fixed to the light source mounting hole; and a light source including a bayonet flange configured to be inserted into the light source mounting hole and, when rotated about the axial direction thereof, to be engaged with the socket fixture. The socket fixture is integrally provided with a snap fit that is capable of being elastically deformed and configured to be engaged with the bayonet flange.

The snap fit extends in the circumferential direction on the inner surface of the socket fixture, and is configured such that one end of the snap fit is connected to the socket fixture and the other end of the snap fit is capable of being elastically deformed in a diametric direction or an axial direction. The other end of the snap fit is provided with a claw body configured to be engaged with the bayonet flange. Further, the claw body is formed in a wedge shape including a front surface and a rear surface which are adjacent to each other along the circumferential direction and formed in predetermined surface angles in relation to the circumferentially tangential direction, respectively, and the surface angle of one surface that faces the rotation direction when the light source is mounted is smaller than the surface angle of the other surface. Here, the bayonet flange may be formed in a petal shape including a plurality of protruding pieces that protrude to the outer diametric direction at a plurality of positions in the circumferential direction, and the snap fit is configured to be engaged with at least one of the protruding pieces.

According to the present disclosure, since the snap fit integrally formed with the socket fixture is elastically deformed to be engaged with the bayonet flange and the light source is mounted in the socket fixture or the lamp body by the engagement, the manipulability may be improved when the light source is mounted due to the elastic deformation of the snap fit. Also, the mounting state of the light source with respect to the lamp body may be maintained. Further, since the snap fit is integrally formed with the socket fixture, the present disclosure may be fabricated at a low cost without increasing the number of the components.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a cross-sectional view of a main part of a first exemplary embodiment.

FIG. 2 is a partial exploded perspective view of the main part of the first exemplary embodiment.

FIG. 3 is a perspective view of a bulb when viewed from the front side.

FIG. 4 is a perspective view of a socket fixture when viewed from the front side.

FIGS. 5A and 5B are front views illustrating the mounting state of the bulb when viewed from the front side.

FIGS. 6A to 6C are schematic views for describing the configuration and functional action of a snap fit.

FIG. 7 is a perspective view of a main part of a socket fixture of a second exemplary embodiment.

FIG. 8 is a perspective view illustrating the mounting structure of a bulb of the second exemplary embodiment when viewed from the front side.

### DETAILED DESCRIPTION

In the following detailed description, reference is made to the accompanying drawing, which form a part hereof The illustrative embodiments described in the detailed description, drawing, and claims are not meant to be limiting. Other embodiments may be utilized, and other changes may be made, without departing from the spirit or scope of the subject matter presented here.

### First Exemplary Embodiment

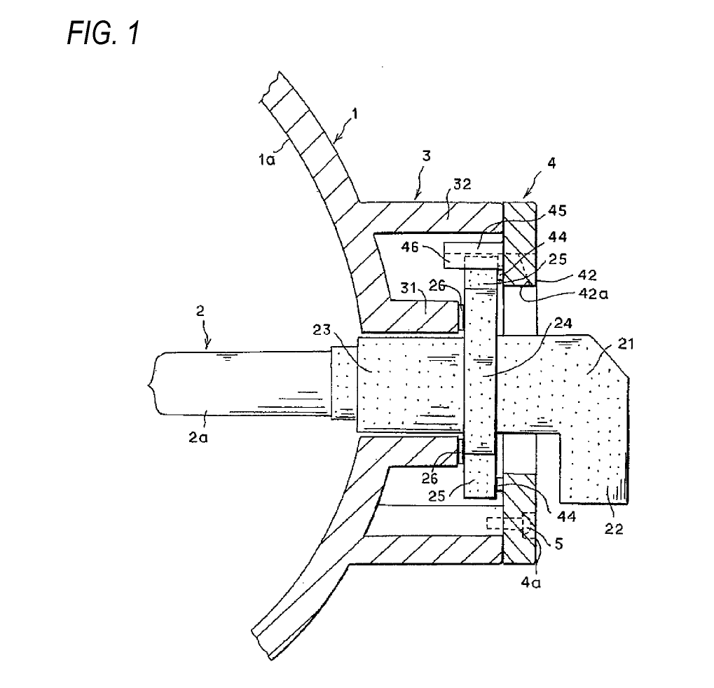

Next, the exemplary embodiments of the present disclosure will be described in detail with reference to the drawings. FIG. 1 is a cross-sectional view of a main part of a first exemplary embodiment in which the present disclosure is applied to a bulb mounting structure of a vehicular lamp. The lamp includes a lamp body having a front lens (not illustrated), and a reflector 1 and a bulb 2 mounted in the reflector 1 as a light source are provided in the lamp body. The inner surface la of the reflector 1 as described above is mirror-finished, the rear surface of the reflector 1 is integrally provided with a bulb mounting hole 3 with a predetermined diameter, and the bulb 2 is detachably mounted in the bulb mounting hole 3. Here, a light-emitting body as the light source is configured by an incandescent bulb (light bulb) 2a, and the incandescent bulb 2a is configured to be maintained in a socket unit 21, and electrically connected to an external power source by a connector 22 provided in the socket unit 21. Since the incandescent bulb 2a and the socket unit 21 are treated as an integral component and often referred to as a bulb, the incandescent bulb 2a together with the socket unit 21 will be referred to as a bulb as a whole.

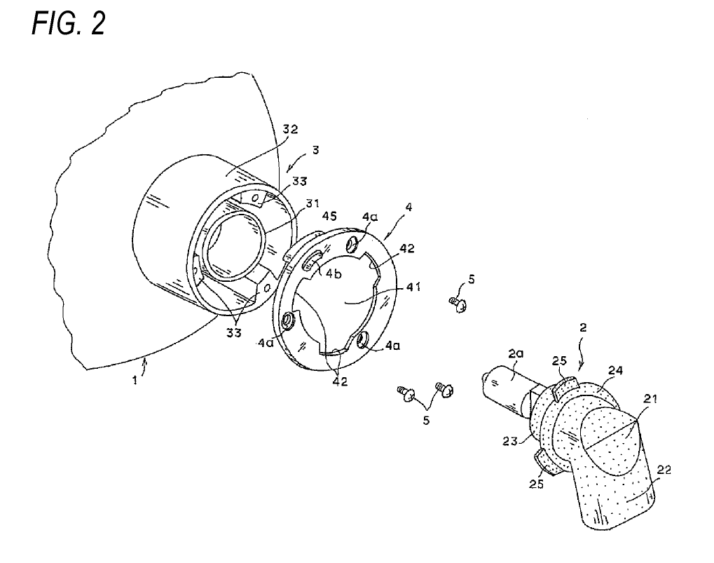

FIG. 2 is an exploded perspective view of the bulb mounting structure as described above. A socket fixture 4 is fixed to the bulb mounting hole 3 of the reflector 1 and the bulb 2 is mounted using the socket fixture 4. In detail, the bulb mounting hole 3 of the reflector 1 is provided with an inner tube 31 of a small diameter and an outer tube 32 of a large diameter. The inner tube 31 and the outer tube 32 are disposed coaxially and protrude from the rear surface of the reflector 1 to the rear side. The protruding length of the inner tube 31 is shorter than the protruding length of the outer tube 32, and the rear end of the inner tube 31 is more deeply located than the rear end of the outer tube 32 by a predetermined depth. Meanwhile, the term “axial direction” in the following description is used to indicate the axial direction of the tubes of the bulb mounting hole 3. Further, rib type rotation stoppers 33 that protrude in an inner diametric direction and extend in the axial direction are integrally provided at a plurality of positions (herein, three positions spaced apart from each other in the circumferential direction of the inner peripheral surface of the outer tube 32), respectively.

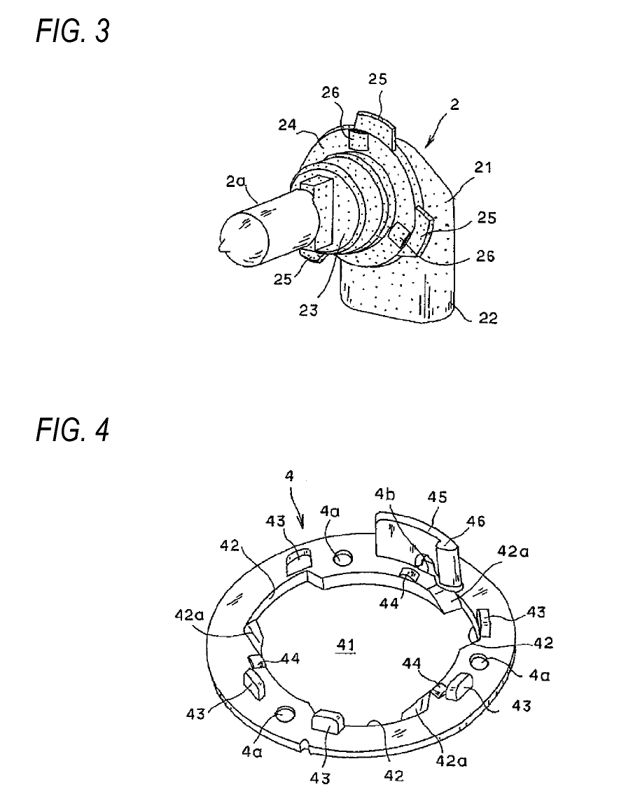

In the bulb 2, the socket unit 21 includes a cylindrical boss 23 configured to be capable of being inserted into the inner tube 31 of the bulb mounting hole 3 and a bayonet flange 24 with a diameter increased in the outer diametric direction is integrally provided at a part of the boss 23 in the axial direction, as illustrated in FIG. 3 which is a perspective view when viewed from the front surface side which is the front side in the axial direction. Three protruding pieces 25 that extend in the outer diametric direction are integrally provided at the three positions of the circumference of the bayonet flange 24, respectively, to form a petal shape as a whole. These protruding pieces 25 are arranged at the circumferential positions which are different from the circumferential positions of the three rotation stoppers 33 provided in the bulb mounting hole 3. Further, a contact protrusion 26 that protrudes toward the front side with a minute thickness is integrally formed at each of three positions of the front surface of the bayonet flange 24 in the circumferential direction which correspond to the three protruding pieces 25, respectively. The contact protrusions 26 come into contact in the rear end of the inner tube 31 of the bulb mounting hole 3 in the axial direction when the bulb 2 is mounted in the bulb mounting hole 3, as described below.

As illustrated in FIG. 4 which is a perspective view in a state where the front surface of the socket fixture 4 faces upward, the socket fixture 4 is configured by a circular plate of which the outer diameter is substantially the same in dimension as the outer diameter of the outer tube 32 of the bulb mounting hole 3, and is fixed to the bulb mounting hole 3 by screwing a small screw 5 to the corresponding one of the rear end surfaces of the three rotation stoppers 33 of the bulb mounting hole 3 through each of three screw holes 4a formed at three positions in the circumference. Further, in the central area of the socket fixture 4, an opened window is provided which is formed in a shape corresponding to the petal shape of the bayonet flange 24 of the bulb 2. That is, a bulb insertion window 41 is formed in the petal shape having a recess portion 42 which extends in the outer diametric direction at each of the three positions in the circumference of the window formed in the circular form. Therefore, the bayonet flange 24 of the bulb 2 may be inserted into the bulb insertion window 41 in the axial direction.

Further, guide protrusions 43, each of which is formed by a small protrusion, are respectively formed to protrude in the axial direction at a plurality of positions in the circumference along the peripheral edge of the bulb insertion window 41 of the inner surface of the socket fixture 4. Each of the guide protrusions 43 serves as a rotation guide for the bayonet flange 24 by being engaged with the peripheral edge of the bayonet flange 24 when the bayonet flange 24 is inserted within the bulb insertion window 41 and is rotated about the axis thereof, as described below. Further, in the socket fixture 4, a taper surface 42a that is inclined in the plate-thickness direction is formed in one end edge of each of the three recess portions 42 of the bulb insertion window 41 (here, the counterclockwise end edge in each of the three recess portions in FIG. 4). The taper surfaces 42a have a function to displace the protruding pieces 25 or the bayonet flange 24 toward the front side in the axial direction by being engaged with the three protruding pieces 25 of the bayonet flange 24 when the bayonet flange 24 is inserted into the bulb insertion window 41 and rotated in the counterclockwise direction. In addition, in the front surface of the socket fixture 4, a pressure portion 44 formed in a gradual curve shape and protruding in a minute dimension in the plate-thickness direction is provided at a position in the vicinity of each taper surface 42a in the counterclockwise direction, and has a function to press the bayonet flange 24 toward the front side in the axial direction, as described below.

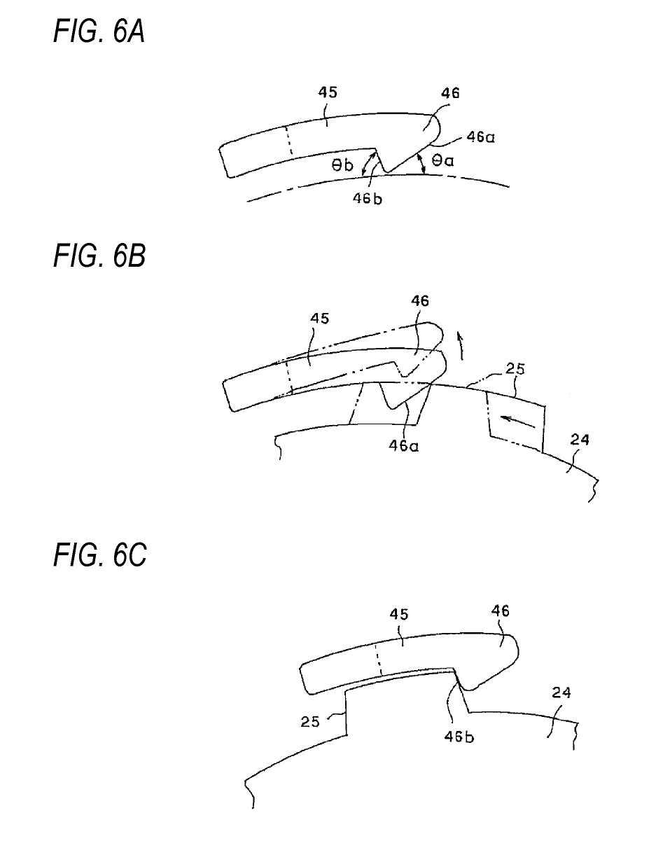

Further, a snap fit 45 is provided integrally with the socket fixture 4 in a region in the vicinity of one of the recess portions 42 in the counterclockwise direction, i.e. in the vicinity of the recess portion 42 located at the one o′clock position in the clockwise in FIG. 4. The snap fit 45 is configured by a circular arc piece with a predetermined dimension which has a desired height in the axial direction and extends in the circumferential direction. A claw body 46 of a wedge shape is provided at the clockwise end of the snap fit 45 in which the claw body 46 protrudes farther in the inner diametric direction than the outer peripheral edge of the recess portion 42. As illustrated in a schematic view of FIG. 6A, the claw body 46 has a front surface 46a that faces the clockwise side and a rear surface 46b that faces the counterclockwise side. Each of the surfaces is formed in an inclined surface. Considering the surface angles θa, θb of the front surface 46a and the rear surface 46b regarding the circumferentially tangential direction, the surface angle θa of the front surface 46a is formed in a smaller angle than the surface angle θb of the rear surface 46b. In addition, in a predetermined length portion including the claw body 46 of the snap fit 45, a thickness reducing portion 4b is provided in the socket fixture 4 by being cut out on the rear side in the axial direction, and thus, the length portion of the snap fit 45 is in a state of being floated from the socket fixture 4 by the thickness reducing portion 4b. As a result, the snap fit 45 is formed as a cantilever member that extends in the peripheral direction, in which one end portion in the counterclockwise side is connected to the socket fixture 4, and other end portion having the claw body 46 in the clockwise side is formed as a free end. Further, since the socket fixture 4 is formed of a slightly elastic material such as, for example, polyamide (PA), the snap fit 45 may be configured such that the free end in the state of being floated from the socket fixture 4, that is, the portion including the claw body 46 may be elastically deformed in the diametric direction.

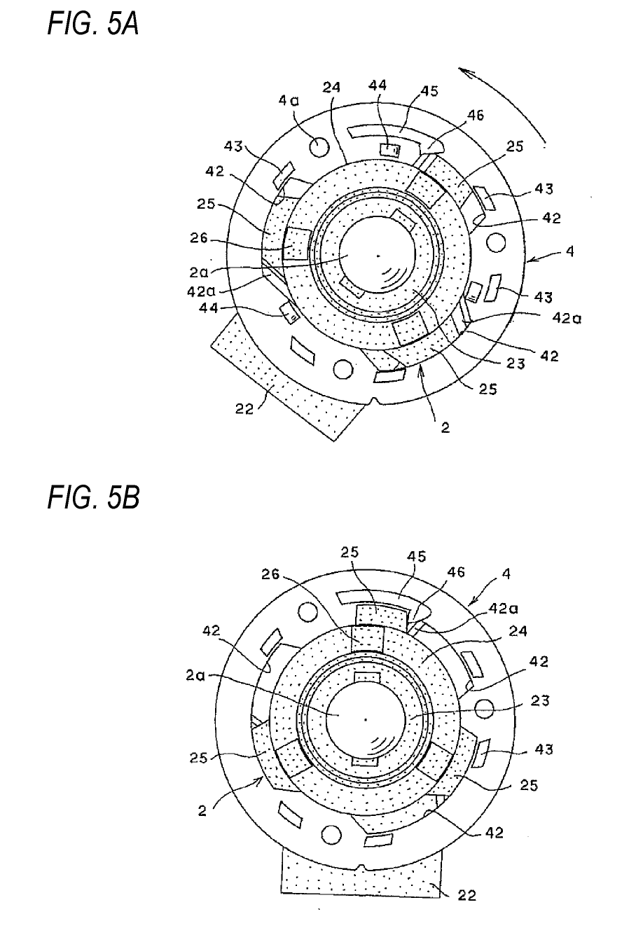

According to the bulb mounting structure in the configuration as described above, the manipulation of mounting/detaching the bulb 2 with respect to the reflector 1 may be performed in the same manner as in the related art. That is, the bulb 2 is inserted into the bulb mounting hole 3 that fixes the socket fixture 4, from the rear side. After positioning the three protruding pieces 25 in relation to the recess portions 42 in the circumferential direction, the bayonet flange 24 is inserted into the bulb insertion window 41 of the socket fixture 4. Therefore, the contact protrusions 26 on the front surface of the bayonet flange 24 are in contact with the rear end of the inner tube 31 of the bulb mounting hole 3. FIG. 5A is a front view of the socket fixture 4, and in the drawing, when the bulb 2 is rotated in the counterclockwise direction (or the clockwise direction when viewed from the rear side of the bulb), each of the peripheral edges of the three protruding pieces 25 of the bayonet flange 24 is guided by the corresponding guide protrusion 43 and rotated along the inner surface of the socket fixture 4. When being rotated by a small angle, the end in the counterclockwise direction of each of the protruding pieces 25 comes into impact contact with one of the taper surfaces 42a of the three recess portions 42 of the socket fixture 4 and is displaced to the front surface side in the axial direction by a wedge effect in the taper surface 42a. When further being rotated, each of the protruding pieces 25 is rotated up to an area where none of the recess portions 42 is formed in the socket fixture 4. Then, when the bulb 2 is further rotated to a position where the rear surface of each of the protruding pieces 25 overlaps with the pressure portion 44 of the socket fixture 4, each protruding piece 25 or the bayonet flange 24 itself, in other words, the entirety of the bulb 2 is pressed to the front side. The contact protrusions 26 of the bulb 2 are strongly contacted with the rear end of the inner tube 31 of the bulb mounting hole 3. As a result, the bayonet flange 24 is axially sandwiched between the inner tube 31 and the inner surface of the socket fixture 4, more specifically, the pressure portion 44, and at the same time, the axial positioning of the bulb 2 in relation to the bulb mounting hole 3 is performed.

Further, according to the rotation of the bulb 2 as described above, one of the protruding pieces 25 of the bayonet flange 24 as illustrated in FIG. 5A comes into an impact contact with the claw body 46 of the snap fit 45 at the front end thereof in the rotating direction, that is, at the counterclockwise end thereof in FIG. 5A. When the bulb 2 is further rotated, the claw body 46 is elastically deformed in the outer diametric direction, and the one of the protruding pieces 25 is continuously rotated while riding over the claw body 46. Then, the bulb 2 is rotated to a predetermined position, and the three protruding pieces 25 are contacted with the rotation stoppers 33 provided in the bulb mounting hole 3, respectively, thereby locking the rotation. At the same time, the one of the protruding pieces 25 rides over the claw body 46 of the snap fit 45 and the claw body 46 is elastically returned to be engaged with the clockwise rear end of the one of the protruding pieces 25. Accordingly, the counterclockwise rotation of the protruding pieces 25 is locked by the rotation stoppers 33 and the clockwise rotation is locked by the claw body 46 of the snap fit 45 so that the bayonet flange 24 or the bulb 2 is restricted in the rotation direction and the positioning thereof is performed.

The surface angle of the front surface 46a of the claw body 46 of the snap fit 45 is small as illustrated in FIG. 6A. Thus, when the front end of a protruding piece 25 of the bayonet flange 24 in the rotation direction comes into an impact contact with the front surface 46a of the claw body 46 as illustrated in FIG. 6B, the bulb 2 may be rotated while deforming the snap fit 45 in the outer diametric direction with a low torque according to the rotation of the bulb 2 as illustrated by chain lines in FIG. 6B. Meanwhile, in a state where a protruding piece 25 rides over the claw body 46, as illustrated in FIG. 6C, the surface angle θb of the rear surface 46b of the claw body 46 is large. Thus, the component of the force in the diametric direction produced by the impact and contact of the rear surface 46b and the protruding piece 25 of the bayonet flange 24 is too small to deform the snap fit 45 in the outer diametric direction. For that reason, it is difficult to rotate the bulb 2 in the opposite direction, that is, in the direction of removing the bulb 2 from the bulb mounting hole 3. Accordingly, the bulb 2 may be suppressed from falling out by external force or vibration.

As described above, in the first exemplary embodiment, when the bulb 2 is mounted in the bulb mounting hole 3, the bayonet flange 24 is engaged with the snap fit 45 to suppress the bulb 2 from falling out. Accordingly, even if a variation in dimension or shape occurs in individual bulbs, specifically even if a slight variation in dimension or shape occurs in the bayonet flange 24, the variation may be absorbed by the elastic deformation of the snap fit 45. Therefore, the bulb 2 may be easily mounted, and the mounting state may be stably maintained. Further, since the snap fit 45 and the socket fixture 4 are integrally formed, a leaf spring as a separate member as in Japanese Patent Application Laid-Open No. 05-135603 is not required. Therefore, the number of the components of the entirety of the mounting apparatus may be reduced, and the mounting apparatus may be fabricated at a low cost.

Meanwhile, when the bulb 2 is separated from the bulb mounting hole 3, if the bulb 2 is strongly rotated in the direction opposite to the mounting direction, a protruding piece 25 of the bayonet flange 24 comes into impact contact with the rear surface 46b of the claw body 46, and the claw body 46 is elastically deformed in the outer diametric direction by the component of the force in the diametric direction. Therefore, the protruding piece 25 may be released from the engagement with the snap fit 45 by riding over the claw body 46 and the bulb 2 may be separated in the same way as in the related art. Even in this case, since the elastic deformation of the snap fit 45 is used, the bulb 2 may be separated by an operation force relatively smaller than the force of suppressing the fall-out of the bulb 2 by the snap fit 45.

### Second Exemplary Embodiment

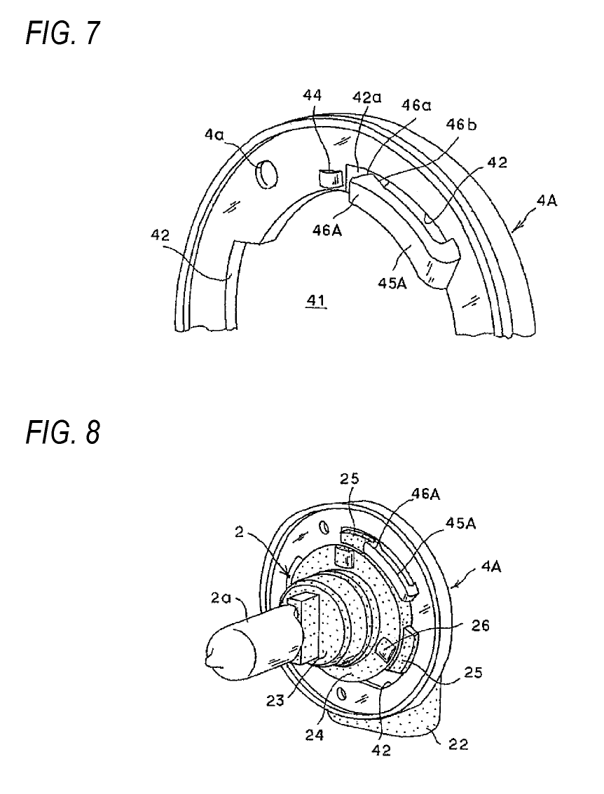

In the first exemplary embodiment, one of the protruding pieces 25 of the bayonet flange 24 is engaged with the snap fit 45 using the elastic deformation in the diametric direction of the snap fit 45. However, the snap fit 45 may be engaged with the protruding piece by elastically deforming the snap fit 45 in the axial direction. FIG. 7 is a perspective view of a main part of a socket fixture 4A according to a second exemplary embodiment which is configured as described above. A snap fit 45A extends in the circumferential direction which is formed in a circular arc shape over an area that covers the front side of one of three recess portions 42 formed in the socket fixture 4A. When viewed from the front side of the socket fixture 4A, the clockwise end of the snap fit 45A is integrally connected to the socket fixture 4A, and the counterclockwise end of the snap fit 45A in the opposite side is configured as a free end which is capable of being elastically deformed in the axial direction. In addition, the free end is integrally provided with a claw body 46A that protrudes rearward. The claw body 46A is disposed to face a taper surface 42a provided in the one of the recess portions 42, and surface angles of the front surface 46a and the rear surface 46b of the claw body 46A directed to the rear side of the claw body 46A are formed such that the surface angle of the front surface 46a facing the counterclockwise direction in FIG. 7 in relation to the circumferentially tangential direction is larger than the surface angle of the rear surface 46b facing the clockwise direction, which is opposite to the first exemplary embodiment. Further, the portions equivalent to those in the first exemplary embodiment are depicted by the same reference numerals.

In the second exemplary embodiment, the movement of each of the components of the apparatus when the bulb 2 is mounted in the bulb mounting hole 3 are basically the same as in the first exemplary embodiment. However, when the bulb 2 is mounted in the bulb mounting hole 3 in the second exemplary embodiment, one of the protruding pieces 25 of the bayonet flange 24 is inserted into the inner side of the snap fit 45, that is, to a position which is more displaced clockwise than the claw body 46A, and the one of the protruding pieces 25 comes into an impact contact with the rear surface 46b of the claw body 46A. As illustrated in FIG. 8, when the bulb 2 is rotated in the counterclockwise direction, the one of the protruding pieces 25 rides over the claw body 46A while elastically deforming the snap fit 45A to the front side by the impact contact with the rear surface 46b of the claw body 46A. When the bulb 2 is rotated to a predetermined position, the one of the protruding pieces 25 is abutted and engaged with the front surface 46a of the claw body 46A, and the rotation in the clockwise direction in FIG. 8 is restricted, thereby suppressing the bulb 2 from falling out.

In the second exemplary embodiment, the surface angle of the rear surface 46b of the claw body 46A is small. Accordingly, when the bulb 2 is rotated to be mounted, the axial component of the force generated by the impact contact of the front-end of the protruding piece 25 of the bayonet flange 24 in the rotation direction and the rear surface 46b of the claw body 46A is so large that the bulb 2 may be rotated while riding over the claw body 46A by deforming the snap fit 45A in the axial direction with a little torque according to the rotation of the bulb 2. Meanwhile, when the protruding piece 25 is engaged with the front surface 46a of the claw body 46A, the surface angle of the front surface 46a is large. Accordingly, the axial component of the force generated by the impact contact of the protruding piece 25 of the bayonet flange 24 and the front surface 46a is too small to deform the snap fit 45A in the axial direction. For that reason, it is difficult to rotate the bulb 2 in a direction where the bulb 2 is removed from the bulb mounting hole 3, and thus, the bulb 2 may be suppressed from falling out by external force or vibration.

Also in the second exemplary embodiment, the falling-out of the bulb 2 is suppressed by engaging the bayonet flange 24 with the snap fit 45A using the elastic deformation of the snap fit 45A. Accordingly, even if a variation in the dimension or shape occurs in individual bulbs, for example, even if a slight variation in dimension or shape occurs in the bayonet flange 24, the variation may be absorbed by the elastic deformation of the snap fit 45A. Therefore, the bulb 2 may be easily mounted. Further, since the snap fit 45A is integrally formed with the socket fixture 4A, the number of the components of the entirety of the apparatus may be reduced, and the apparatus may be fabricated at a low cost.

The snap fit according to the present disclosure is not limited to the shapes of the first and second exemplary embodiments as long as the snap fit is integrally formed with the socket fixture. For example, the engaging direction of the protruding piece of the bayonet flange in relation to the snap fit may be appropriately changed. For example, the snap fit of the first exemplary embodiment may be formed in the circumferentially opposite direction so that one of the protruding pieces may be engaged with the claw body of the snap fit from the rear side to the front side of the claw body. Alternatively, the snap fit of the second exemplary embodiment may be formed in the circumferentially opposite direction so that the protruding piece may be engaged with the claw body of the snap fit from the front side to the rear side of the claw body. Further, the snap fit is not limited to a single one. If a margin is present in space, a number of snap fits corresponding to the number of the protruding pieces of the bayonet flange, that is, two or three snap fits may be provided.

Although the above-described exemplary embodiments have been described as being applied to a vehicular lamp using a bulb as a light source, the exemplary embodiments may be applied as a structure to mount the light-emitting element in a reflector even in a vehicular lamp using a semiconductor light-emitting element such as, for example, a light-emitting diode (LED) or a laser diode (LD) as the light source.

The present disclosure may be adopted to a structure to mount a light source in a reflector by fixing a socket fixture to the reflector and engaging a bayonet flange provided in the light source with the socket fixture.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A light source mounting structure of a vehicular lamp comprising:
a light source mounting hole provided in a reflector;
a socket fixture configured to be fixed to the light source mounting hole; and
a light source including a bayonet flange configured to be inserted into the light source mounting hole and, when rotated about an axial direction thereof, to be engaged with the socket fixture,
wherein the socket fixture is integrally provided with a snap fit that is capable of being elastically deformed and configured to be engaged with the bayonet flange.

2. The light source mounting structure of claim 1, wherein the snap fit extends in the circumferential direction on the inner surface of the socket fixture, and is configured such that one end is connected to the socket fixture and the other end is capable of being elastically deformed in a diametric direction or an axial direction, the other end of the snap fit being provided with a claw body configured to be engaged with the bayonet flange.

3. The light source mounting structure of claim 2, wherein the claw body is formed in a wedge shape including a front surface and a rear surface which are adjacent to each other in the circumferential direction and formed in predetermined surface angles in relation to the circumferentially tangential direction, respectively, and the surface angle of one surface that faces the rotation direction when the light source is mounted is smaller than the surface angle of the other surface.

4. The light source mounting structure of claim 1, wherein the bayonet flange is formed in a petal shape including a plurality of protruding pieces that protrude to the outer diametric direction at a plurality of positions in the circumferential direction, respectively, and the snap fit is configured to be engaged with at least one of the protruding pieces.

5. The light source mounting structure of claim 2, wherein the bayonet flange is formed in a petal shape including a plurality of protruding pieces that protrude to the outer diametric direction at a plurality of positions in the circumferential direction, respectively, and the snap fit is configured to be engaged with at least one of the protruding pieces.

6. The light source mounting structure of claim 3, wherein the bayonet flange is formed in a petal shape including a plurality of protruding pieces that protrude to the outer diametric direction at a plurality of positions in the circumferential direction, respectively, and the snap fit is configured to be engaged with at least one of the protruding pieces.
